(19) United States
(12) Patent Application Publication
(10) Pub. No.: US 2026/0116487 A1
(43) Pub. Date: Apr. 30, 2026

(54) SADDLE WITH HANDLE ASSEMBLY FOR CHILDREN

(71) Applicant: DDK GROUP CO., LTD. TAIWAN BRANCH, TAICHUNG CITY (TW)

(72) Inventor: YING-CHIAO SUNG, TAICHUNG CITY (TW)

(21) Appl. No.: 18/965,061

(22) Filed: Dec. 2, 2024

(30) Foreign Application Priority Data
Oct. 25, 2024 (TW) 113211621

(51) Int. Cl. B62J 1/08

(52) U.S. Cl. CPC B62J 1/08

(57) ABSTRACT

A saddle with a handle assembly for children includes a saddle body; a base support shell arranged on a bottom of the saddle body, the base support shell including a front edge and a rear edge; and a bracket combined with a bottom of the base support shell. A handle assembly is combined with the bottom of the base support shell at a location of the rear edge, so that a handle for children is combinable through the handle assembly. The handle assembly includes a mounting base positioned on the bottom of the base support shell; an extension bar combined with a bottom of the mounting base and extended downwards for a predetermined length; and a handle positioning member combined with a bottom end of the extension bar to allow the handle to fix to the bottom end of the extension bar.

### BACKGROUND OF THE INVENTION

### 1. Field of the Invention

The present invention relates to a saddle, and more particularly to a saddle with a handle assembly for children.

### 2. The Related Arts

Cycling is now quite popular, and various ancillary equipment are also widely used and become more professional. In the bicycle saddle structure, it mainly includes a base support shell and a saddle body combined with a top surface of the base support shell. In order to attach the saddle to a bicycle, a bracket made of metal is combined with the base support shell of the saddle. The saddle is combined with a seat tube of the bicycle by means of the bracket and assembling components.

In traditional structural designs, the saddle functions only as a saddle for a bicycle rider to sit thereon. Therefore, when bicycle riders go out on bicycles, each individual person can only ride his or her own bicycle. However, when children need to travel together, they can only be carried in the back seat and rely only on the children to hold on to the rider's body or clothing. In this way, the balance stability and driving safety of children sitting in the back seat will pose a huge problem.

Although saddle accessories or attachments with different types of functions are currently sold on the market, there is no design that combines the saddle with a handle for gripping by a child.

### SUMMARY OF THE INVENTION

Thus, an objective of the present invention is to provide a saddle with handle assembly for children in order to provide a handle that is grippable by a child on a bicycle saddle.

To achieve the objective, the present invention provides a saddle with handle assembly for children, comprising a saddle body; a base support shell arranged on a bottom of the saddle body, the base support shell comprising a front edge and a rear edge; and a bracket combined with a bottom of the base support shell. A handle assembly is combined with the bottom of the base support shell at a location of the rear edge, so that the handle assembly is combinable with a handle for gripping by children. The handle assembly comprises a mounting base positioned on the bottom of the base support shell; an extension bar combined with a bottom of the mounting base and extended downwards for a predetermined length; and a handle positioning member combined with a bottom end of the extension bar to allow a handle to fix to the bottom end of the extension bar.

In efficacy, the present invention provides a bicycle saddle that includes a handle for gripping by children, so that when a bicycle rider is riding the bicycle, a child sitting in the back seat can hold the exclusive handle at the same time, and this improves balance stability and riding safety for a child sitting on the back seat. As to applications, the handle assembly of the present invention is applicable to various applications, such as parent-child bicycles, parent-child amusement vehicles, electric-assisted bicycles, electric-assisted vehicles, amusement equipment.

The specific technology adopted in the present invention will be further described with reference to embodiments provided below and the attached drawings.

### BRIEF DESCRIPTION OF THE DRAWINGS

FIG. 1 is a perspective view showing a saddle with a handle assembly for children according to the present invention;

FIG. 2 is an exploded view illustrating various components of the saddle with a handle assembly for children according to the present invention in a detached state;

FIG. 3 is a right-side elevational view showing the saddle with a handle assembly for children according to the present invention shown in FIG. 1;

FIG. 4 is a front view showing the saddle with a handle assembly for children according to the present invention shown in FIG. 1;

FIG. 5 is a rear view showing the saddle with a handle assembly for children according to the present invention shown in FIG. 1;

FIG. 6 is a rear-side perspective view showing the saddle with a handle assembly for children according to the present invention; and

FIG. 7 is a rear-side exploded view illustrating various components of the saddle with a handle assembly for children according to the present invention shown in FIG. 6 in a detached state.

### DETAILED DESCRIPTION OF THE PREFERRED EMBODIMENTS

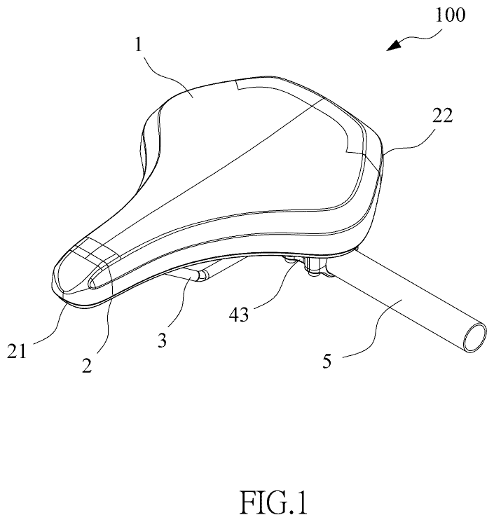

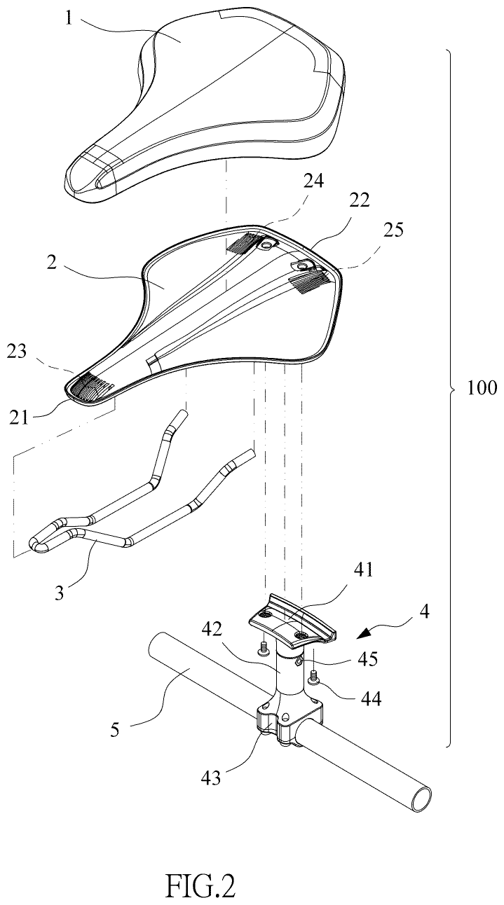

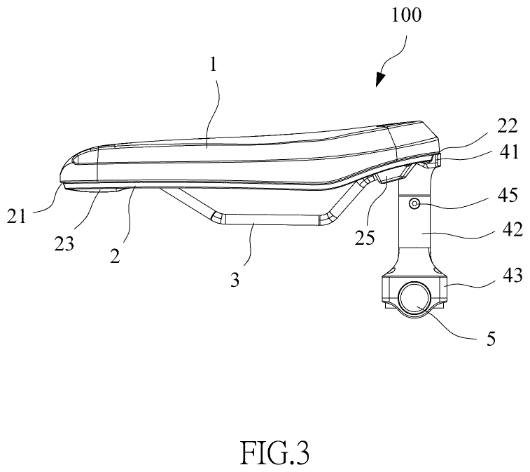

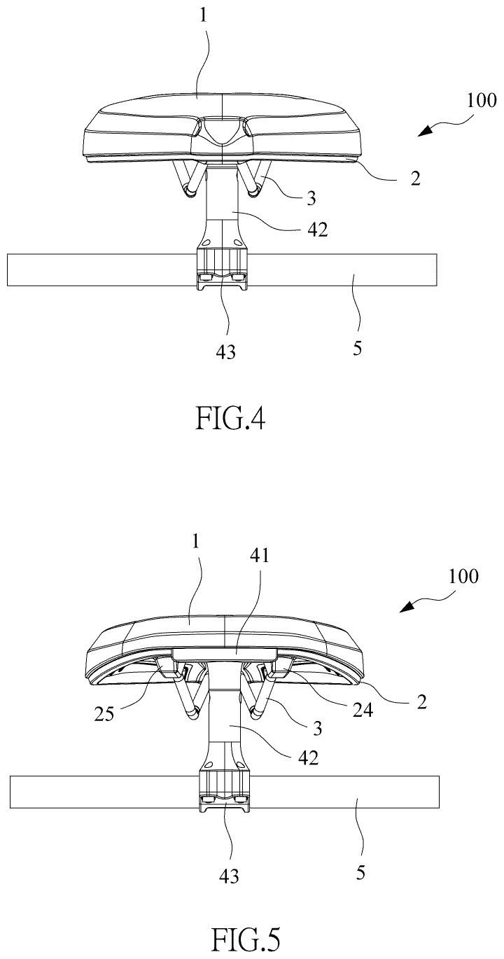

Referring to FIGS. 1-5, a saddle with a handle assembly for children according to the present invention, generally designated at 100, comprises a saddle body 1 and a base support shell 2, wherein the base support shell 2 is arranged on a bottom of the saddle body 1. A surface of the saddle body 2 can be further externally covered with an outer covering layer (not shown).

A bottom of the base support shell 2 is combined with a bracket 3 located between a front edge 21 and a rear edge 22, so that the saddle 100 with handle assembly for children according to the present invention is combinable with a seat tube of a bicycle (not shown) by means of the bracket 3 in combination with known assembling components. The bottom of the base support shell 2 is combined with a handle assembly 4 on the rear edge 22, and a handle 5 that is provided for being gripped by a child can be mounted by means of the handle assembly 4.

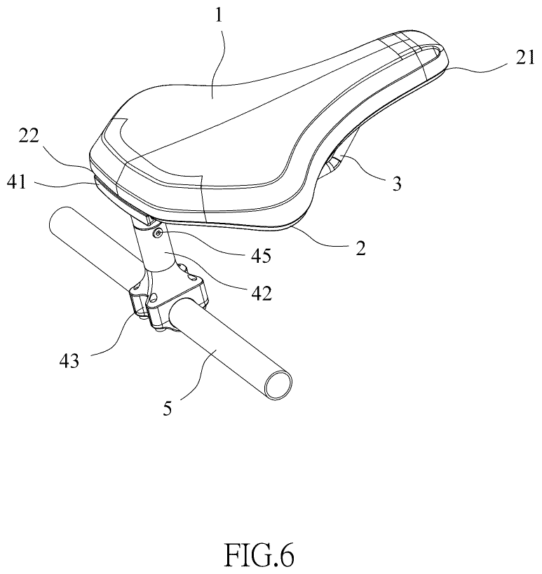

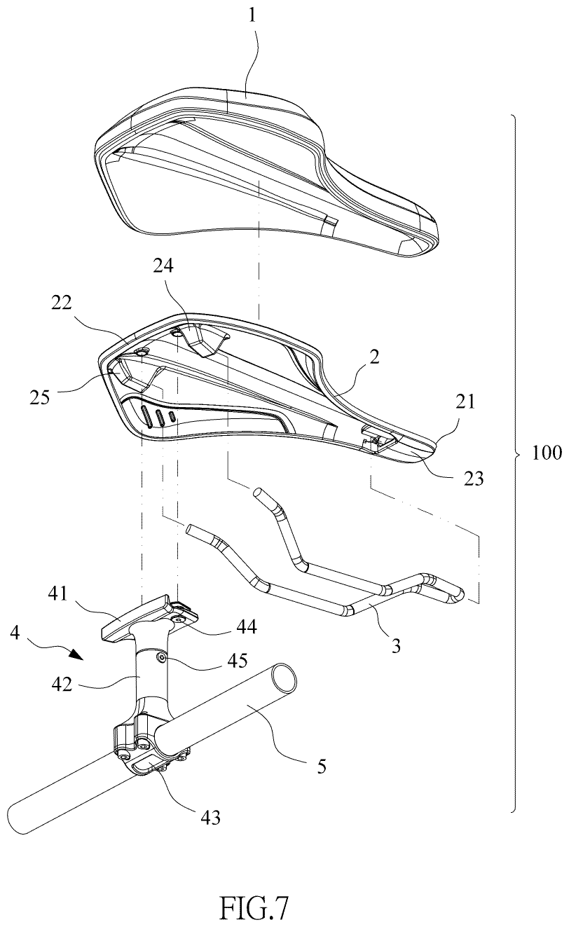

Referring jointly to FIGS. 6-7, the base support shell 2 is provided with a front connecting part 23 that is set at a location adjacent to the front edge 21, and a left connecting part 24 and a right connecting part 25 that are opposite to each other and set at locations adjacent to the rear edge 22 of the base support shell 2 in such a way that the left connecting part 24 and the right connecting part 25 are spaced from each other by a gap therebetween.

A front end of the bracket 3 is fit into and fixed in the front connecting part 23 of the base support shell 2, and two rear ends of the bracket 3 are respectively fit into and fixed in the left connecting part 24 and the right connecting part 25 of the base support shell 2, so that the bracket 3 is securely combined with the bottom of the base support shell 2.

The handle assembly 4 comprises a mounting base 41 positioned between the left connecting part 24 and the right connecting part 25 of the base support shell 2. An extension bar 42 is combined with a bottom of the mounting base 41 and is extended downward for a predetermined length. A bottom of the extension bar 42 is connected to a handle positioning member 43, so that the handle 5 is receivable in a through hole formed in the handle positioning member 43 to be mounted on the bottom of the extension bar 42.

The mounting base 41 may be positioned and fixed on the base support shell 2 between the left connecting part 24 and the right connecting part 25 by means of bolt elements 44 or a locking member or a simple quick release member. In an example of using a quick release member to position and fix the mounting base 41 on the bottom of the base support shell 2, the saddle 100 with handle assembly for children according to the present invention can be easily and quickly mounted to or removed from the base support shell 2. In other examples, the mounting base 41 can be integrally formed on the bottom of the base support shell 2 as a one-piece structure.

Preferably, the extension bar 42 may be made in the form of an extendable/retractable bar that enables adjustment of the length thereof and is fastened in position by means of a fastening element. As such, a user is allowed to adjust the length of the extension bar 42 as desired and to fix and keep the length by using the fastening element 45.

The saddle 100 with handle assembly for children according to the present invention is combinable with a seat tube of a regular bicycle by means of the bracket 3 and known assembling components. With respect to applications, the handle assembly 4 of the present invention can also be used in various applications, such as parent-child bicycles, parent-child amusement vehicles, electric-assisted bicycles, electric-assisted vehicles, and amusement equipment.

The above-described embodiments are provided only for describing the present invention and are not intended to limit the scope of the present invention. Those skilled in the art may contemplate modifications and variations of the above-described embodiments within the structural arrangements and spirit of the present invention, and such variations are considered falling in the spirit of the present invention and the claims provided below. Thus, the scope of protection of the present invention is solely defined by the appended claims.

What is claimed is:

1. A saddle, comprising:
a saddle body;
a base support shell arranged on a bottom of the saddle body, including a front edge and a rear edge opposite to the front edge; and
a bracket combined with a bottom of the base support shell;
wherein the bottom of the base support shell is combined with a handle assembly at a location of the rear edge, the handle assembly including a handle grippable by a child.

2. The saddle according to claim 1, wherein a front connecting part is provided on the bottom of the base support shell at a location adjacent to the front edge, a left connecting part is provided on the bottom of the base support shell at a locations adjacent to the rear edge, and a right connecting part spaced from the left connecting part by a gap therebetween is provided on the bottom of the base support shell at a locations adjacent to the rear edge, wherein a front end of the bracket is fit into and fixed in the front connecting part of the base support shell and two rear ends of the bracket are respectively fit into and fixed in the left connecting part and the right connecting part of the base support shell, so as to have the bracket securely combined with the bottom of the base support shell.

3. The saddle according to claim 1, wherein the handle assembly comprises:
a mounting base, which is positioned on the bottom of the base support shell and located between the left connecting part and the right connecting part;
an extension bar, which is combined with a bottom of the mounting base and is extended downwards for a predetermined length; and
a handle positioning member, which is combined with a bottom end the extension bar to receive the handle and to position the handle to the bottom end of the extension bar.

4. The saddle according to claim 3, wherein the extension bar is an extendable bar that enables adjustment of a length thereof.

5. The saddle according to claim 3, wherein, after adjustment of the length of the extension bar as desired, a fastening element is applicable to fix and keep the length.

6. The saddle according to claim 3, wherein the mounting base is positioned on the bottom of the base support shell by one of a bolt element and a locking member.

7. The saddle according to claim 3, wherein the mounting base is positioned on the bottom of the base support shell by a quick release assembly.

8. The saddle according to claim 3, wherein the mounting base is integrally formed on the bottom of the base support shell.
